(19) United States
(12) Patent Application Publication
(10) Pub. No.: US 2026/0326459 A1
(43) Pub. Date: Oct. 22, 2026

(54) DRYING DEVICE AND PRINTING DEVICE

(71) Applicant: SEIKO EPSON CORPORATION, Tokyo (JP)

(72) Inventor: Tomohiro YODA, MATSUMOTO-SHI (JP)

(21) Appl. No.: 19/649,380

(22) Filed: Apr. 16, 2026

(30) Foreign Application Priority Data
Apr. 18, 2025 (JP) 2025-068641

(51) Int. Cl. B41J 11/00

(52) U.S. Cl. CPC B41J 11/00218; B41J 11/00216; B41J 11/0022; B41J 11/007

(57) ABSTRACT

A drying device facing a support base that supports a medium to be transported includes a first heater unit and a second heater unit, and the first heater unit includes a first heating element that extends in a first direction and radiates infrared rays, and a first reflection plate that reflects the infrared rays radiated by the first heating element toward the support base, the second heater unit includes a second heating element that extends in the first direction and radiates infrared rays, and a second reflection plate that reflects the infrared rays radiated by the second heating element toward the support base, the second heating element is located at a position different from a position of the first heating element in the first direction and a second direction that is a direction different from the first direction and in which the medium transported on the support base moves, and the second reflection plate reflects the infrared rays such that the infrared rays overlap a region on the support base irradiated with the infrared rays reflected by the first reflection plate in the second direction.

The present application is based on, and claims priority from JP Application Serial Number 2025-068641, filed Apr. 18, 2025, the disclosure of which is hereby incorporated by reference herein in its entirety.

### BACKGROUND

### 1. Technical Field

The present disclosure relates to a drying device and a printing device.

### 2. Related Art

JP-A-2017-132174 describes a drying device that dries a transported medium. The drying device includes a first heater unit that heats the medium from above, and a second heater unit that heats the medium from below. The first heater unit and the second heater unit are lined up in one direction and thus dry the medium over the width thereof.

JP-A-2017-132174 is an example of the related art.

In the drying device described in JP-A-2017-132174, the first heater unit and the second heater unit heat the medium from different surfaces. Therefore, the medium may not be uniformly dried.

### SUMMARY

According to an aspect of the present disclosure, a drying device facing a support base that supports a medium to be transported is provided, and the drying device includes: a first heater unit that heats the medium; and a second heater unit that heats the medium, and the first heater unit includes a first heating element that extends in a first direction and radiates infrared rays, and a first reflection plate that reflects the infrared rays radiated by the first heating element toward the support base, the second heater unit includes a second heating element that extends in the first direction and radiates infrared rays, and a second reflection plate that reflects the infrared rays radiated by the second heating element toward the support base, the second heating element is located at a position different from a position of the first heating element in the first direction and a second direction that is a direction different from the first direction and in which the medium transported on the support base moves, and the second reflection plate reflects the infrared rays such that the infrared rays overlap a region on the support base irradiated with the infrared rays reflected by the first reflection plate in the second direction.

According to another aspect of the present disclosure, a printing device includes: a printing unit that ejects a liquid to a medium and thus performs printing; a transport unit that transports the medium; a support base that supports the medium to which the liquid is ejected; a first heater unit that faces the support base and heats the medium; and a second heater unit that faces the support base and heats the medium, and the first heater unit includes a first heating element that extends in a first direction and radiates infrared rays, and a first reflection plate that reflects the infrared rays radiated by the first heating element toward the support base, the second heater unit includes a second heating element that extends in the first direction and radiates infrared rays, and a second reflection plate that reflects the infrared rays radiated by the second heating element toward the support base, the second heating element is located at a position different from a position of the first heating element in the first direction and a second direction that is a direction different from the first direction and in which the medium transported on the support base moves, and the second reflection plate reflects the infrared rays such that the infrared rays overlap a region on the support base irradiated with the infrared rays reflected by the first reflection plate in the second direction.

### BRIEF DESCRIPTION OF THE DRAWINGS

FIG. 1 is a side view showing an example of a printing device including a drying device.

FIG. 2 is a side view illustrating an example of the drying device.

FIG. 3 is a plan view showing a heater unit.

FIG. 4 is a plan view showing a modified example of the drying device.

FIG. 5 is a side view showing a modified example different from FIG. 4.

FIG. 6 is a side view showing a modified example different from FIGS. 4 and 5.

### DESCRIPTION OF EMBODIMENTS

Hereinafter, an example of a printing device will be described with reference to the drawings. The printing device is an inkjet printer that ejects an ink, which is an example of a liquid, onto a medium such as a paper or cloth, and thus prints an image such as a character or picture thereon.

### Printing Device

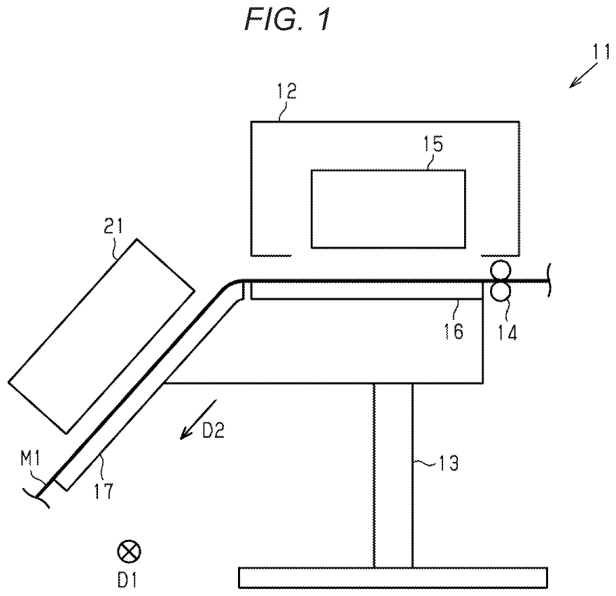

As illustrated in FIG. 1, a printing device 11 includes a housing 12. The printing device 11 may include a base 13. The base 13 supports the housing 12. Specifically, the base 13 supports the housing 12 from below.

The printing device 11 includes a transport unit 14. The transport unit 14 is configured to transport a medium M1. The transport unit 14 includes, for example, one or more rollers. The transport unit 14 transports the medium M1 with one or more rollers.

The transport unit 14 transports the medium M1 that is long. The transport unit 14 may transport the medium M1 that is a single sheet. In one example, the transport unit 14 transports the medium M1 fed from a roll body formed by winding the medium M1 before printing. The transport unit 14 may transport the medium M1 fed from a roll body held by the printing device 11. The transport unit 14 may transport the medium M1 fed from a roll body held by a device different from the printing device 11.

The printing device 11 includes a printing unit 15. The printing unit 15 is housed in the housing 12. The printing unit 15 is configured to print an image on the medium M1. The printing unit 15 ejects a liquid onto the medium M1 and thus prints an image on the medium M1. The recording unit 15 includes, for example, a head that ejects the liquid. The printing unit 15 may include a serial head that scans the medium M1, or may include a line head configured to be able to simultaneously eject the liquid over the width of the medium M1.

The printing device 11 includes a print support base 16. The print support base 16 is configured to support the medium M1. The print support base 16 supports the medium M1 from below. The print support base 16 supports the medium M1 transported by the transport unit 14. The print support base 16 is located to face the printing unit 15. The print support base 16 supports the medium M1 on which printing is performed by the printing unit 15. In one example, the print support base 16 supports a part of the medium M1 where printing is in progress.

The printing device 11 includes a support base 17. The support base 17 is configured to support the medium M1. The support base 17 supports the medium M1 from below. The support base 17 supports the medium M1 transported by the transport unit 14. The support base 17 is located downstream of the print support base 16 in the direction in which the medium M1 is transported. The support base 17 supports the medium M1 on which printing is already finished by the printing unit 15. In one example, the support base 17 supports a part of the medium M1 where printing is already finished. The support base 17 may continue from the print support base 16 or may be separated from the print support base 16.

The printing device 11 includes a drying device 21. The drying device 21 is configured to dry the medium M1. The drying device 21 dries the transported medium M1. The drying device 21 dries the printed medium M1. The drying device 21 is located to face the support base 17. The drying device 21 dries the medium M1 supported by the support base 17. The drying device 21 dries the medium M1 transported on the support base 17. The drying device 21 dries a part of the medium M1 located on the support base 17.

### Drying Device

Next, the drying device 21 will be described.

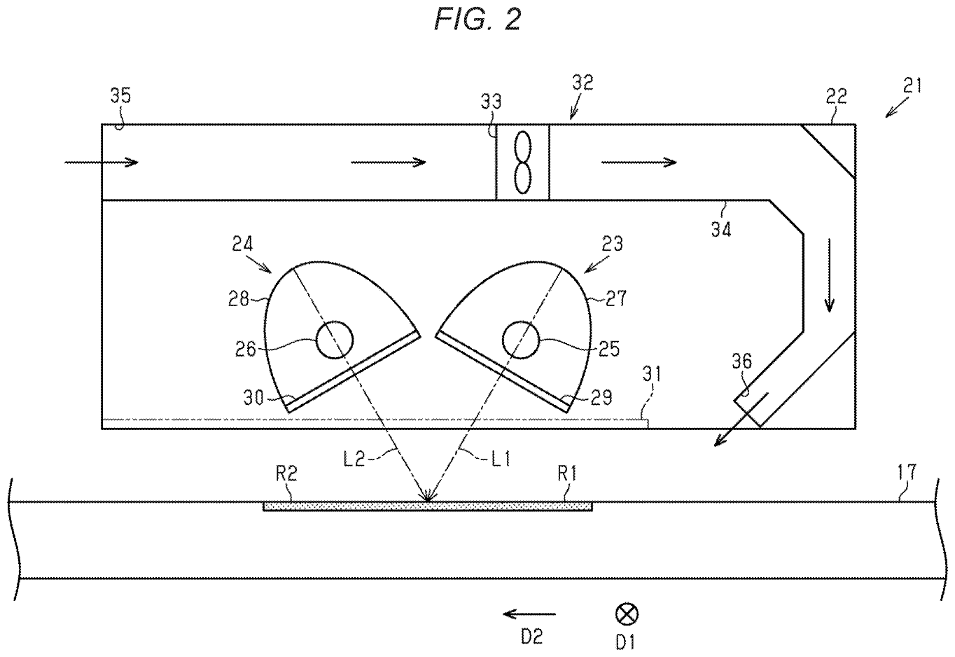

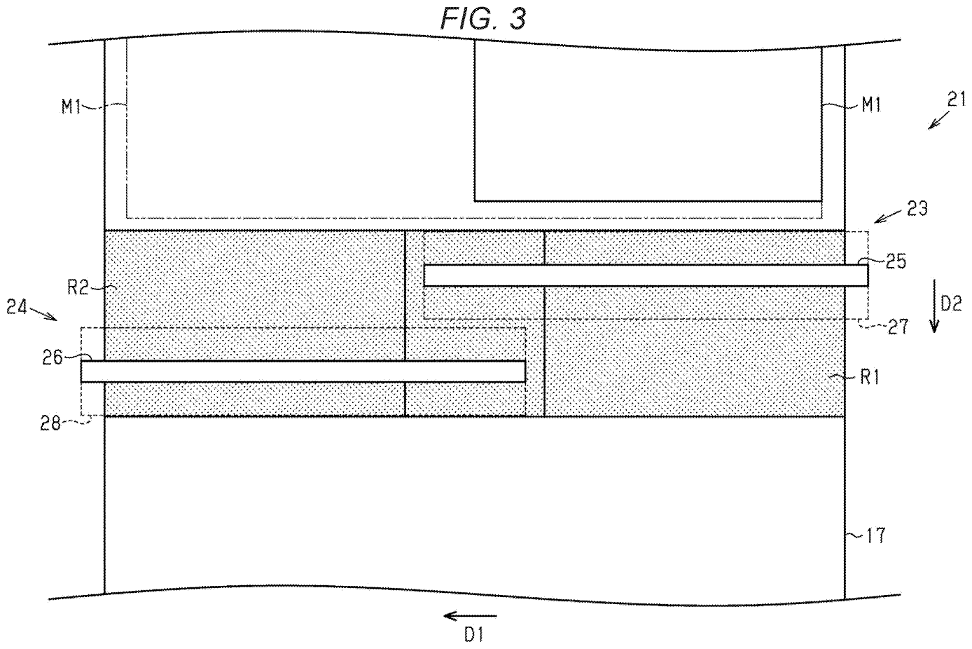

As illustrated in FIGS. 2 and 3, the drying device 21 includes a case 22. The case 22 is located to face the support base 17. The case 22 is configured such that a part facing the support base 17 opens.

The drying device 21 includes a plurality of heater units. In one example, two heater units are provided. Specifically, the drying device 21 includes a first heater unit 23 and a second heater unit 24. The heater unit is housed in the case 22. The heater unit is located to face the support base 17.

The heater unit is configured to heat the medium M1. The heater unit emits infrared rays toward the support base 17. The heater unit heats the medium M1 transported on the support base 17 with infrared rays. The heater unit dries the medium M1 by heating the medium M1.

The heater unit heats the medium M1 located in an irradiation region. The irradiation region is a region where infrared rays emitted from the heater unit reach. The irradiation region is a region on the support base 17. The irradiation region is determined, based on the position, posture, and the like of the heater unit. The first heater unit 23 heats the medium M1 located in a first irradiation region R1. The first irradiation region R1 is a region where infrared rays emitted from the first heater unit 23 reach. The second heater unit 24 heats the medium M1 located in a second irradiation region R2. The second irradiation region R2 is a region where infrared rays emitted from the second heater unit 24 reach. The medium M1 is transported and thus enters the irradiation region. Thus, the medium M1 is heated.

The heater unit is configured to extend in a first direction D1. The first direction D1 is a direction serving as an indicator indicating the width of the medium M1. The first heater unit 23 and the second heater unit 24 are long in the first direction D1. Since the heater unit extends in the first direction D1, the heater unit can heat the medium M1 over the width thereof.

The plurality of heater units are located so as to be able to heat the medium M1 over the entire width thereof. The plurality of heater units are located such that the medium M1 of the maximum size printed by the printing device 11 can be heated over the entire width thereof. In one example, the plurality of heater units are located so as to be able to heat the top of the support base 17 over the entire width thereof. The plurality of heater units are located such that the irradiation regions continue from each other in the first direction D1.

The first heater unit 23 and the second heater unit 24 are located so as to be able to complementarily heat the medium M1 in the first direction D1. Specifically, the second heater unit 24 is located so as to emit infrared rays to a region where infrared rays from the first heater unit 23 are unlikely to reach in the first direction D1. The second heater unit 24 is located such that the second irradiation region R2 continues from the first irradiation region R1 in the first direction D1. For example, the second heater unit 24 is located as extended from the first heater unit 23 in the first direction D1. Thus, the medium M1 having a relatively small width can be heated by the first heater unit 23 alone or by the second heater unit 24 alone. The medium M1 having a relatively large width can be heated by the first heater unit 23 and the second heater unit 24. As the heater unit to be driven is selected according to the width of the medium M1, the power consumption of the drying device 21 is reduced.

The plurality of heater units may be located such that the plurality of irradiation regions overlap each other in the first direction D1. In other words, the plurality of heater units may be positioned such that the plurality of irradiation regions overlap each other when viewed from a second direction D2. For example, the first heater unit 23 and the second heater unit 24 may be located such that the end parts of the first irradiation region R1 and the second irradiation region R2 overlap each other when viewed from the second direction D2. The amount of infrared rays at the end parts of the irradiation regions tends to be smaller than the amount of infrared rays at a central part of the irradiation regions. Therefore, since the end parts of the irradiation regions overlap each other, the medium M1 is easily dried uniformly.

The plurality of heater units are located at different positions in the second direction D2. The second direction D2 is a direction different from the first direction D1. The second direction D2 is a direction in which the medium M1 is transported on the support base 17. The plurality of heater units are located to be lined up in the second direction D2 when viewed from the first direction D1. For example, the first heater unit 23 and the second heater unit 24 are located to be lined up in this order in the second direction D2. The second heater unit 24 and the first heater unit 23 may be located to be lined up in this order in the second direction D2.

The plurality of heater units are located such that the plurality of irradiation regions overlap each other in the second direction D2. In other words, the plurality of heater units are located such that the plurality of irradiation regions overlap each other when viewed from the first direction D1. For example, the first heater unit 23 and the second heater unit 24 are located such that the first irradiation region R1 and the second irradiation region R2 overlap each other when viewed from the first direction D1. When the first irradiation region R1 and the second irradiation region R2 are shifted from each other in the second direction D2, the timing at which the transported medium M1 is heated differs in the first direction D1. That is, when the first irradiation region R1 and the second irradiation region R2 are shifted from each other in the second direction D2, the timing of the medium M1 entering the first irradiation region R1 and the timing of the medium M1 entering the second irradiation region R2 are different from each other. In this case, the medium M1 may not be uniformly dried. However, since the first irradiation region R1 and the second irradiation region R2 overlap each other when viewed from the first direction D1, the discrepancy of the timing at which the medium M1 is heated is reduced. The first irradiation region R1 and the second irradiation region R2 may be located so as to completely overlap each other when viewed from the first direction D1. The first irradiation region R1 and the second irradiation region R2 may be located so as to partially overlap each other when viewed from the first direction D1.

The heater unit includes one or more heating elements. The first heater unit 23 includes one or more first heating elements 25. The second heater unit 24 includes one or more second heating elements 26. In one example, the first heater unit 23 includes one first heating element 25. The second heater unit 24 includes one second heating element 26. The heating element extends in the first direction D1.

The heating element is configured to radiate infrared rays. Specifically, the heating element radiates infrared rays when a voltage is applied thereto. The heating element includes, for example, an electric heating wire and a tube that accommodates the electric heating wire. The heating element radiates infrared rays as the electric heating wire heats the tube. The heating element extends, for example, in a cylindrical shape. In one example, the heating element is a sheathed heater. The heating element radially radiates infrared rays.

The first heating element 25 and the second heating element 26 are located at different positions from each other in the first direction D1. The first heating element 25 and the second heating element 26 are located to be shifted from each other when viewed from the second direction D2. In one example, the first heating element 25 and the second heating element 26 are located such that the end parts thereof overlap each other when viewed from the second direction D2. Thus, the end parts of the first irradiation region R1 and the second irradiation region R2 overlap each other when viewed from the second direction D2.

The first heating element 25 and the second heating element 26 are located at different positions from each other in the second direction D2. The first heating element 25 and the second heating element 26 are located to be shifted from each other when viewed from the first direction D1. In one example, the first heating element 25 and the second heating element 26 are located to be lined up in the second direction D2 when viewed from the first direction D1. The first heating element 25 and the second heating element 26 are located to be lined up in this order in the second direction D2.

The heater unit includes one or more reflection plates. The first heater unit 23 includes one or more first reflection plates 27. The second heater unit 24 includes one or more second reflection plates 28. The reflection plate is configured to reflect the infrared rays radiated from the heating element toward the support base 17. The reflection plate is configured to cover the heating element. The reflection plate is configured to cover the heating element from above. The reflection plate is, for example, a curved plate.

The reflection plate is located such that the irradiation regions overlap each other in the second direction D2. The reflection plate is located such that the irradiation regions overlap each other when viewed from the first direction D1. The first reflection plate 27 is located such that the first irradiation region R1 overlaps the second irradiation region R2 when viewed from the first direction D1. The second reflection plate 28 is located such that the first irradiation region R1 overlaps the second irradiation region R2 when viewed from the first direction D1.

The reflection plate reflects the infrared rays in a direction in which a normal line thereto extends. The normal line is a straight line extending from the apex of the curved reflection plate toward the support base 17. The reflection plate covers the heating element such that the heating element is located on the normal line thereto. The first reflection plate 27 reflects the infrared rays in the direction in which a first normal line L1 extends. The first reflection plate 27 covers the first heating element 25 such that the first heating element 25 is located on the first normal line L1. The second reflection plate 28 reflects the infrared rays in the direction in which a second normal line L2 extends. The second reflection plate 28 covers the second heating element 26 such that the second heating element 26 is located on the second normal line L2.

The first reflection plate 27 and the second reflection plate 28 are located such that the first normal line L1 and the second normal line L2 extend in different directions from each other when viewed from the first direction D1. The first reflection plate 27 and the second reflection plate 28 are located, for example, such that the first normal line L1 and the second normal line L2 are directed toward the same position on the support base 17 when viewed from the first direction D1. Thus, the first irradiation region R1 and the second irradiation region R2 overlap each other when viewed from the first direction D1.

The first reflection plate 27 is located such that the first normal line L1 extends in a direction different from the second normal line L2 when viewed from the first direction D1. In one example, the first reflection plate 27 is located such that the first normal line L1 is inclined with respect to the support base 17 when viewed from the first direction D1. Specifically, the first reflection plate 27 is located such that the first normal line L1 includes a component toward the second direction D2 when viewed from the first direction D1. The first normal line L1 may extend perpendicularly to the support base 17.

The second reflection plate 28 is located such that the second normal line L2 extends in a direction different from the first normal line L1 when viewed from the first direction D1. In one example, the second reflection plate 28 is located such that the second normal line L2 is inclined with respect to the support base 17 when viewed from the first direction D1. Specifically, the second reflection plate 28 is located such that the second normal line L2 includes a component toward a direction opposite to the second direction D2 when viewed from the first direction D1. The second normal line L2 may extend perpendicularly to the support base 17.

The distance between the first heating element 25 and the support base 17 on the first normal line L1 and the distance between the second heating element 26 and the support base 17 on the second normal line L2 may be the same. The irradiation area of the infrared rays on the support base 17 changes depending on the distance between the heating element and the support base 17. As the distance between the heating element and the support base 17 decreases, the infrared rays become less likely to be diffused to the support base 17.

The height of the first heating element 25 from the support base 17 and the height of the second heating element 26 from the support base 17 may be the same. In this case, when the first normal line L1 and the second normal line L2 are symmetrically inclined with respect to the support base 17, the distances between the heating elements and the support base 17 on the normal lines are likely to be the same.

The drying device 21 may include one or more transmission members. In one example, the drying device 21 includes a first transmission member 29 and a second transmission member 30. The drying device 21 may include only the first transmission member 29 or may include only the second transmission member 30. The drying device 21 may include a common transmission member 31 instead of the first transmission member 29 and the second transmission member 30. The drying device 21 may include the common transmission member 31 in addition to the first transmission member 29, or may include the common transmission member 31 in addition to the second transmission member 30.

The transmission member is a member that transmits infrared rays. The transmission member is configured to have a high infrared transmittance. The transmission member may be formed of, for example, a glass plate made of quartz glass or a wire mesh. The transmission member transmits infrared rays and limits the flow of gases. The transmission member is located to protect the heating element from the outside air. Therefore, the heating element is less likely to come into contact with the outside air. This reduces the risk that the temperature of the heating element may be lowered by the outside air.

The transmission member is located to transmit the infrared rays emitted from the heater unit to the support base 17. Specifically, the transmission member is located to transmit the infrared rays emitted from the heating element. The transmission member is located between the heating element and the support base 17. The first transmission member 29 is located between the first heating element 25 and the support base 17. The second transmission member 30 is located between the second heating element 26 and the support base 17. The common transmission member 31 is located between the first heating element 25 and the support base 17 and between the second heating element 26 and the support base 17.

The transmission member may be attached to the reflection plate. The transmission member may be attached so as to surround the heating element with the reflection plate and the transmission member. The transmission member may be attached to the reflection plate so as to close the opening in the reflection plate, for example. Thus, the outside air is less likely to enter the space covered by the reflection plate. In this case, the transmission member may be formed of a wire mesh or a glass plate. The first transmission member 29 is attached to the first reflection plate 27. The first transmission member 29 is attached so as to surround the first heating element 25 by the first reflection plate 27 and the first transmission member 29. The second transmission member 30 is attached to the second reflection plate 28. The second transmission member 30 is attached so as to surround the second heating element 26 with the second reflection plate 28 and the second transmission member 30.

The transmission member may be attached to the case 22. The transmission member may be attached to the case 22 so as to close the opening in the case 22. Thus, the outside air is less likely to enter the inside of the case 22. In this case, the transmission member may be formed of a glass plate. In terms of infrared transmittance, a glass plate is better than a wire mesh. Therefore, when the transmission member is located at a position away from the heating element, the transmission member may be formed of a glass plate. The common transmission member 31 is attached to the case 22.

The drying device 21 may include a blower unit 32. The blower unit 32 is attached to the case 22. The blower unit 32 is configured to perform blowing to the support base 17. The blower unit 32 performs blowing to the medium M1 transported on the support base 17. As the blower unit 32 performs blowing to the medium M1, the drying of the medium M1 is facilitated.

The blower unit 32 performs blowing to the support base 17 such that a gas flows over the support base 17. In one example, the blower unit 32 blows a gas such that the gas flows in the second direction D2 over the support base 17. The blower unit 32 may blow a gas such that the gas flows in the direction opposite to the second direction D2 over the support base 17. The blower unit 32 blows, for example, air to the support base 17.

The blower unit 32 includes a fan 33. The fan 33 is configured to cause a gas to flow. The blower unit 32 has a blowing path 34. The blowing path 34 is attached to the case 22. The blowing path 34 extends inside the case 22. In one example, the blowing path 34 extends so as to cover the heater unit. Thus, the blowing path 34 is easily warmed. The blowing path 34 is a path through which the gas made to flow by the fan 33 flows. The fan 33 is located in the blowing path 34. When the fan 33 is driven, the gas flows along the blowing path 34.

An intake port 35 is open in the blowing path 34. The intake port 35 is an opening through which the gas flows into the blowing path 34. As the fan 33 is driven, the gas flows into the blowing path 34 through the intake port 35. In one example, the intake port 35 is located at a position shifted in the second direction D2 from the heater unit. That is, the intake port 35 is located downstream of the heater unit in the direction in which the medium M1 is transported on the support base 17.

An outlet port 36 is open in the blowing path 34. The outlet port 36 is an opening through which the gas flows out from the blowing path 34. As the fan 33 is driven, the gas flows out from the blowing path 34 through the outlet port 36. In one example, the outlet port 36 is located at a position shifted in the direction opposite to the second direction D2 from the heater unit. That is, the outlet port 36 is located upstream of the heater unit in the direction in which the medium M1 is transported on the support base 17. Thus, the gas blown out from the outlet port 36 easily flows in the second direction D2 over the support base 17.

The outlet port 36 is located such that the distance between the first heater unit 23 and the outlet port 36 is shorter than the distance between the second heater unit 24 and the outlet port 36 in the second direction D2. Specifically, the outlet port 36 is located such that the distance between the first heater unit 23 and the outlet port 36 is shorter than the distance between the second heater unit 24 and the outlet port 36 in the second direction D2. More specifically, the outlet port 36 is located such that the distance between the first reflection plate 27 and the outlet port 36 is shorter than the distance between the second reflection plate 28 and the outlet port 36 in the second direction D2. That is, the first reflection plate 27 is located closer to the outlet port 36 than the second reflection plate 28. Therefore, the first heating element 25 may come into contact with the gas blown out from the outlet port 36. In this regard, the first reflection plate 27 is located to block the space between the first heating element 25 and the outlet port 36. For example, the first reflection plate 27 is located such that the direction in which the first normal line L1 extends is close to the direction in which the gas is blown out from the outlet port 36, and thus blocks the space between the first heating element 25 and the outlet port 36. This reduces the risk that the temperature of the first heating element 25 may decrease.

### Functions and Effects of Example

Next, the functions and effects of the above example will be described.

(1) The second heating element 26 is located at a position different from the position of the first heating element 25 in the first direction D1 and the second direction D2. The second reflection plate 28 reflects the infrared rays such that the infrared rays overlap the first irradiation region R1 in the second direction D2. According to the above configuration, the first heater unit 23 and the second heater unit 24 heat the medium M1 from the same surface. Since the first irradiation region R1 and the second irradiation region R2 overlap each other in the second direction D2, the discrepancy between the timing at which the first heater unit 23 heats the medium M1 and the timing at which the second heater unit 24 heats the medium M1 is reduced. Thus, the drying device 21 can uniformly dry the medium M1.

(2) The second reflection plate 28 is located such that the second normal line L2 extends in a direction different from the first normal line L1 when viewed from the first direction D1. According to the above configuration, the first irradiation region R1 and the second irradiation region R2 easily overlap each other in the second direction D2.

(3) The drying device 21 includes the blower unit 32 that performs blowing to the support base 17 so that a gas flows over the support base 17. The first reflection plate 27 is located such that the distance between the first reflection plate 27 and the outlet port 36 is shorter than the distance between the second reflection plate 28 and the outlet port 36 in the second direction D2. The first reflection plate 27 is located so as to block the space between the outlet port 36 and the first heating element 25. According to the above configuration, the drying of the medium M1 is facilitated by the blowing by the blower unit 32. Since the first reflection plate 27 is located so as to block the space between the outlet port 36 and the first heating element 25, the risk that the temperature of the first heating element 25 may decrease due to the blowing by the blower unit 32 is reduced.

(4) The drying device 21 includes the transmission member that is located between the first heating element 25 and the support base 17 and transmits infrared rays. According to the above configuration, the transmission member makes the first heating element 25 less likely to come into contact with the outside air. This reduces the risk that the temperature of the first heating element 25 may decrease due to the outside air.

(5) The drying device 21 includes the first transmission member 29. The first transmission member 29 is attached to the first reflection plate 27 so as to surround the first heating element 25 with the first reflection plate 27 and the first transmission member 29. According to the above configuration, since the first reflection plate 27 and the first transmission member 29 surround the first heating element 25, the risk that the temperature of the first heating element 25 may decrease due to the outside air is reduced.

(6) The drying device 21 includes the second transmission member 30 that is located between the second heating element 26 and the support base 17 and transmits infrared rays. According to the above configuration, the second transmission member 30 makes the second heating element 26 less likely to come into contact with the outside air. This reduces the risk that the temperature of the second heating element 26 in addition to the first heating element 25 may decrease due to the outside air.

(7) The second transmission member 30 is attached to the second reflection plate 28 so as to surround the second heating element 26 with the second reflection plate 28 and the second transmission member 30. According to the above configuration, since the second reflection plate 28 and the second transmission member 30 surround the second heating element 26, the risk that the temperature of the second heating element 26 may decrease due to the outside air is reduced.

(8) The common transmission member 31 is located between the first heating element 25 and the support base 17 and between the second heating element 26 and the support base 17. According to the above configuration, the common transmission member 31 makes the first heating element 25 and the second heating element 26 less likely to come into contact with the outside air. This reduces the risk that the temperature of the first heating element 25 and the temperature of the second heating element 26 may decrease due to the outside air.

### Modification Examples

The above embodiment can be implemented with modifications given below. The above embodiment and the modification examples given below can be implemented in combination to the extent that no technical contradictions occur.

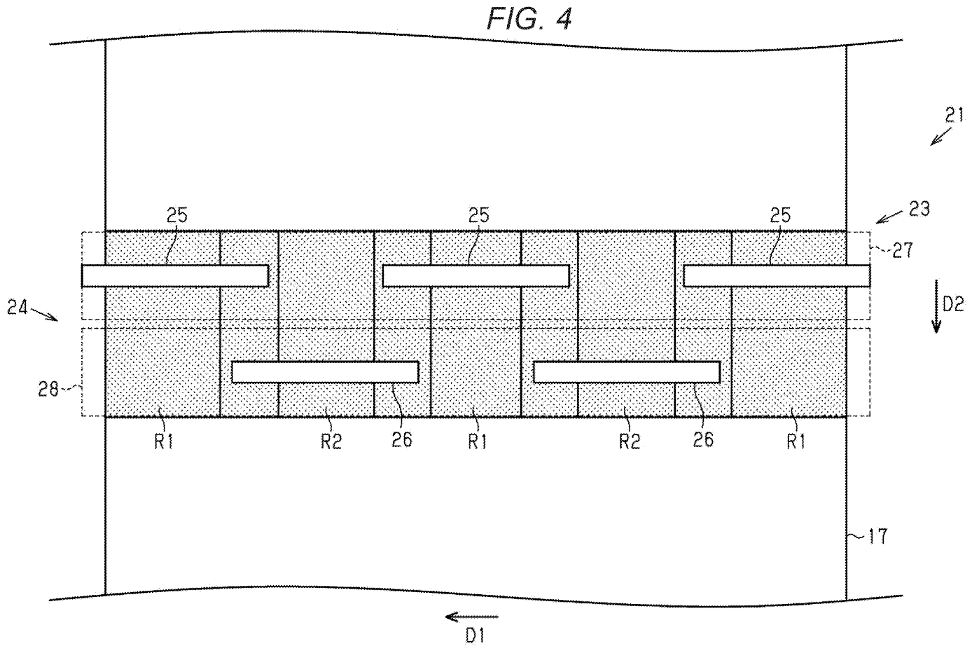

As illustrated in FIG. 4, the heater unit may include a plurality of heating elements. In this modification example, each of the first heater unit 23 and the second heater unit 24 includes a plurality of heating elements. One of the first heater unit 23 and the second heater unit 24 may include a plurality of heating elements. Since the heater unit includes a plurality of heating elements, a heating element to be driven can be finely selected according to the width of the medium M1. Thus, the power consumption of the drying device 21 is reduced.

The first heater unit 23 includes a plurality of first heating elements 25. In one example, the first heater unit 23 includes three first heating elements 25. The plurality of first heating elements 25 are located to be lined up at intervals in the first direction D1. The plurality of first heating elements 25 are located at different positions from each other in the first direction D1. For example, the three first heating elements 25 are located to face a central part and both end parts of the support base 17 in the first direction D1, respectively. The plurality of first heating elements 25 are located at the same position in the second direction D2. That is, the plurality of first heating elements 25 are located so as to overlap each other when viewed from the first direction D1. The plurality of first heating elements 25 are located to be lined up at intervals on an imaginary axis extending in the first direction D1.

The second heater unit 24 includes a plurality of second heating elements 26. In one example, the second heater unit 24 includes two second heating elements 26. The plurality of second heating elements 26 are located to be lined up at intervals in the first direction D1. The second heating elements 26 are located at different positions from the plurality of first heating elements 25 in the first direction D1. The plurality of second heating elements 26 are located at different positions from each other in the first direction D1. The plurality of second heating elements 26 are located between two first heating elements 25 adjacent to each other in the first direction D1. The plurality of second heating elements 26 are located complementarily with respect to the plurality of first heating elements 25. The plurality of second heating elements 26 are located at the same position in the second direction D2. That is, the plurality of second heating elements 26 are located so as to overlap each other when viewed from the first direction D1. The plurality of second heating elements 26 are located to be lined up at intervals on an imaginary axis extending in the first direction D1.

The plurality of first heating elements 25 and the plurality of second heating elements 26 are located to be alternately lined up in the first direction D1. The plurality of first heating elements 25 and the plurality of second heating elements 26 are located to be lined up in alternation in the first direction D1.

The first reflection plate 27 may be configured to cover the plurality of first heating elements 25. The first reflection plate 27 may extend to be long in the first direction D1. The first heater unit 23 may include the first reflection plate 27 for each first heating element 25. The first heater unit 23 may include the same number of first reflection plates 27 as the first heating elements 25.

The second reflection plate 28 may be configured to cover the plurality of second heating elements 26. The second reflection plate 28 may extend to be long in the first direction D1. The second heater unit 24 may include the second reflection plate 28 for each second heating element 26. The second heater unit 24 may include the same number of second reflection plates 28 as the second heating elements 26.

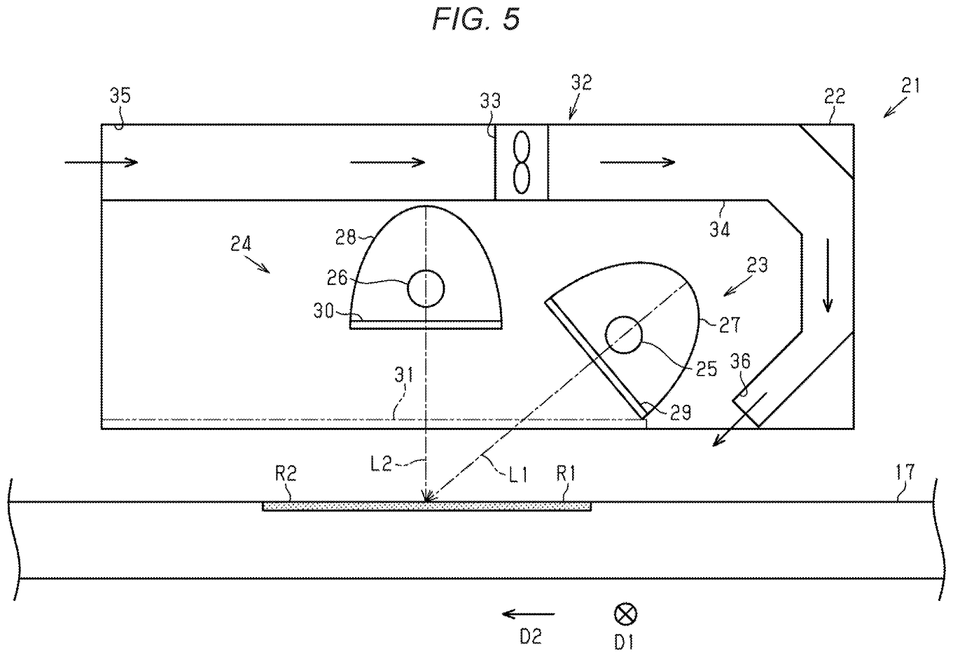

As shown in FIG. 5, the reflection plate may be located such that the normal line thereto is perpendicular to the support base 17. In this modification example, the second reflection plate 28 is positioned such that the second normal line L2 is perpendicular to the support base 17. The first reflection plate 27 is located such that the first irradiation region R1 overlaps the second irradiation region R2. The first reflection plate 27 is located such that the first normal line L1 is inclined with respect to the support base 17.

The first reflection plate 27 may be located such that the first normal line L1 is perpendicular to the support base 17. In this case, the second reflection plate 28 is located such that the second normal line L2 is inclined with respect to the support base 17.

The height of the first heating element 25 from the support base 17 may be lower than the height of the second heating element 26 from the support base 17. When the normal line is inclined with respect to the support base 17, the distance between the heating element and the support base 17 on the normal line is likely to be longer than when the normal line is perpendicular to the support base 17. Therefore, as the height of the first heating element 25 from the support base 17 is reduced, the distance between the first heating element 25 and the support base 17 on the first normal line L1 becomes close to the distance between the second heating element 26 and the support base 17 on the second normal line L2.

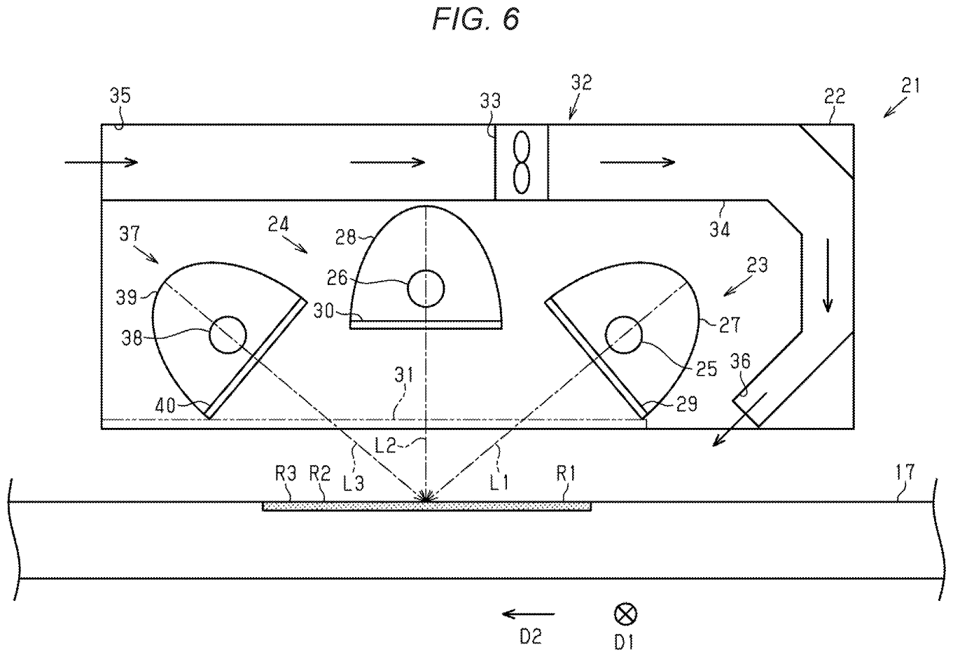

As shown in FIG. 6, the drying device 21 may include a third heater unit 37. The third heater unit 37 is located at a position different from the first heater unit 23 and the second heater unit 24 in the second direction D2. The third heater unit 37 is located at a position shifted in the second direction D2 from the first heater unit 23 and the second heater unit 24. The first heater unit 23, the second heater unit 24, and the third heater unit 37 are lined up, for example, in this order in the second direction D2.

The first heater unit 23, the second heater unit 24, and the third heater unit 37 are located so as to be able to complementarily heat the medium M1 in the first direction D1. That is, the third heater unit 37 is located so as to emit infrared rays to a region where the infrared rays from the first heater unit 23 and the second heater unit 24 are unlikely to reach in the first direction D1. The third heater unit 37 is located such that a third irradiation region R3 continues from the first irradiation region R1 or the second irradiation region R2 in the first direction D1. The third irradiation region R3 is a region on the support base 17 where the infrared rays emitted from the third heater unit 37 reach.

The third heater unit 37 is located such that the third irradiation region R3 overlaps the first irradiation region R1 and the second irradiation region R2 when viewed from the first direction D1. The first irradiation region R1, the second irradiation region R2, and the third irradiation region R3 may be located so as to completely overlap each other when viewed from the first direction D1. The first irradiation region R1, the second irradiation region R2, and the third irradiation region R3 may be located so as to partially overlap each other when viewed from the first direction D1.

The third heater unit 37 includes one or more third heating elements 38. In one example, the third heater unit 37 includes one third heating element 38. The third heating element 38 is located at a position different from the first heating element 25 and the second heating element 26 in the first direction D1. The third heating element 38 is located so as to be shifted from the first heating element 25 and the second heating element 26 when viewed from the second direction D2.

The third heating element 38 is located at a position different from the first heating element 25 and the second heating element 26 in the second direction D2. The third heating element 38 is located so as to be shifted from the first heating element 25 and the second heating element 26 when viewed from the first direction D1.

The third heater unit 37 includes one or more third reflection plates 39. The third reflection plate 39 is located such that the third irradiation region R3 overlaps the first irradiation region R1 and the second irradiation region R2 in the second direction D2. The third reflection plate 39 is located such that the third irradiation region R3 overlaps the first irradiation region R1 and the second irradiation region R2 when viewed from the first direction D1.

The third reflection plate 39 reflects the infrared rays in the direction in which a third normal line L3 extends. The third reflection plate 39 covers the third heating element 38 such that the third heating element 38 is located on the third normal line L3. The third reflection plate 39 is located such that the third normal line L3 extends in a direction different from each of the first normal line L1 and the second normal line L2 when viewed from the first direction D1. For example, the third reflection plate 39 is located such that the third normal line L3 is directed to a part where the first normal line L1 and the second normal line L2 intersect the support base 17 when viewed from the first direction D1. Thus, the third irradiation region R3 overlaps the first irradiation region R1 and the second irradiation region R2 when viewed from the first direction D1.

The third reflection plate 39 may be located such that the third normal line L3 is inclined with respect to the support base 17 when viewed from the first direction D1. For example, the third reflection plate 39 is located such that the third normal line L3 extends, including a component directed in the direction opposite to the second direction D2, when viewed from the first direction D1. The third normal line L3 may extend perpendicularly to the support base 17.

The drying device 21 may include a third transmission member 40. The third transmission member 40 is located between the third heating element 38 and the support base 17. The third transmission member 40 is attached to the third reflection plate 39. The third transmission member 40 is attached so as to surround the third heating element 38 with the third reflection plate 39 and the third transmission member 40.

The drying device 21 may include the common transmission member 31. The common transmission member 31 may be located between the first heating element 25 and the support base 17, between the second heating element 26 and the support base 17, and between the third heating element 38 and the support base 17.

### Technical Ideas

Technical ideas figured out from the above embodiment and modification examples, and effects and advantages thereof will be described below.

(A) A drying device facing a support base that supports a medium to be transported is provided, and the drying device includes: a first heater unit that heats the medium; and a second heater unit that heats the medium, and the first heater unit includes a first heating element that extends in a first direction and radiates infrared rays, and a first reflection plate that reflects the infrared rays radiated by the first heating element toward the support base, the second heater unit includes a second heating element that extends in the first direction and radiates infrared rays, and a second reflection plate that reflects the infrared rays radiated by the second heating element toward the support base, the second heating element is located at a position different from a position of the first heating element in the first direction and a second direction that is a direction different from the first direction and in which the medium transported on the support base moves, and the second reflection plate reflects the infrared rays such that the infrared rays overlap a region on the support base irradiated with the infrared rays reflected by the first reflection plate in the second direction. According to the above configuration, the first heater unit and the second heater unit heat the medium from the same surface. The region irradiated with infrared rays by the first heater unit and the region irradiated with infrared rays by the second heater unit overlap each other in the second direction. Therefore, the discrepancy between the timing at which the first heater unit heats the medium and the timing at which the second heater unit heats the medium is reduced. Thus, the drying device can uniformly dry the medium.

(B) In the drying device, the second reflection plate may be located such that a normal line to the second reflection plate extends in a direction different from a normal line to the first reflection plate when viewed from the first direction. According to the above configuration, the region irradiated with infrared rays by the first heater unit and the region irradiated with infrared rays by the second heater unit easily overlap each other in the second direction.

(C) In the drying device, the first heater unit may include a plurality of first heating elements, the first heating element may be one of the plurality of first heating elements, and the plurality of first heating elements may be lined up at intervals in the first direction. According to the above configuration, the first heating element to be driven can be selected from among the plurality of first heating elements according to the width of the medium. Thus, power consumption is reduced.

(D) In the drying device, the first reflection plate may extend in the first direction so as to cover the plurality of first heating elements. According to the above configuration, the configuration of the first heater unit can be simplified as compared with when the first heater unit includes the first reflection plate for each first heating element.

(E) In the drying device, the second heater unit may include a plurality of second heating elements, the second heating element may be one of the plurality of second heating elements, and the plurality of second heating elements may be located at positions different from the plurality of first heating elements in the first direction and lined up at intervals in the first direction. According to the above configuration, the second heating element to be driven can be selected from among the plurality of second heating elements according to the size of the medium. Thus, power consumption is reduced.

(F) In the drying device, the second reflection plate may extend in the first direction so as to cover the plurality of second heating elements. According to the above configuration, the configuration of the second heater unit can be simplified as compared with when the second heater unit includes the second reflection plate for each second heating element.

(G) The drying device may include a blower unit that performs blowing to the support base such that a gas flows over the support base, the blower unit may include a fan that causes the gas to flow and a blowing path in which an outlet port is open through which the gas made to flow by the fan is blown out, and the first reflection plate may be located such that a distance between the first reflection plate and the outlet port is shorter than a distance between the second reflection plate and the outlet port in the second direction, and may be located to block a space between the outlet port and the first heating element. According to the above configuration, the drying of the medium is facilitated by the blowing by the blower unit. Since the first reflection plate is located so as to block the space between the outlet port and the first heating element, the risk that the temperature of the first heating element may decrease due to the blowing by the blower unit is reduced.

(H) The drying device may include a transmission member that is located between the first heating element and the support base and transmits infrared rays. According to the above configuration, the transmission member makes the first heating element less likely to come into contact with the outside air. This reduces the risk that the temperature of the first heating element may decrease due to the outside air.

(I) In the drying device, the transmission member may be attached to the first reflection plate so as to surround the first heating element with the first reflection plate and the transmission member. According to the above configuration, since the first reflection plate and the transmission member surround the first heating element, the risk that the temperature of the first heating element may decrease due to the outside air is reduced.

(J) In the drying device, the transmission member may be a first transmission member, and the drying device may include a second transmission member that is located between the second heating element and the support base and transmits infrared rays. According to the above configuration, the second transmission member makes the second heating element less likely to come into contact with the outside air. This reduces the risk that the temperature of the second heating element in addition to the first heating element may decrease due to the outside air.

(K) In the drying device, the second transmission member may be attached to the second reflection plate so as to surround the second heating element with the second reflection plate and the second transmission member. According to the above configuration, since the second reflection plate and the second transmission member surround the second heating element, the risk that the temperature of the second heating element may decrease due to the outside air is reduced.

(L) In the drying device, the transmission member may be located between the first heating element and the support base and between the second heating element and the support base. According to the above configuration, the transmission member makes the first heating element and the second heating element less likely to come into contact with the outside air. This reduces the risk that the temperature of the first heating element and the temperature of the second heating element may decrease due to the outside air.

(M) A printing device includes: a printing unit that ejects a liquid to a medium and thus performs printing; a transport unit that transports the medium; a support base that supports the medium to which the liquid is ejected; a first heater unit that faces the support base and heats the medium; and a second heater unit that faces the support base and heats the medium, and the first heater unit includes a first heating element that extends in a first direction and radiates infrared rays, and a first reflection plate that reflects the infrared rays radiated by the first heating element toward the support base, the second heater unit includes a second heating element that extends in the first direction and radiates infrared rays, and a second reflection plate that reflects the infrared rays radiated by the second heating element toward the support base, the second heating element is located at a position different from a position of the first heating element in the first direction and a second direction that is a direction different from the first direction and in which the medium transported on the support base moves, and the second reflection plate reflects the infrared rays such that the infrared rays overlap a region on the support base irradiated with the infrared rays reflected by the first reflection plate in the second direction. According to the above configuration, effects similar to those of the drying device described above can be achieved.

What is claimed is:

1. A drying device facing a support base that supports a medium to be transported, the drying device comprising:
a first heater unit that heats the medium; and
a second heater unit that heats the medium, wherein the first heater unit includes a first heating element that extends in a first direction and radiates infrared rays, and
a first reflection plate that reflects the infrared rays radiated by the first heating element toward the support base,
the second heater unit includes a second heating element that extends in the first direction and radiates infrared rays, and
a second reflection plate that reflects the infrared rays radiated by the second heating element toward the support base,
the second heating element is located at a position different from a position of the first heating element in the first direction and a second direction that is a direction different from the first direction and in which the medium transported on the support base moves, and
the second reflection plate reflects the infrared rays such that the infrared rays overlap a region on the support base irradiated with the infrared rays reflected by the first reflection plate in the second direction.

2. The drying device according to claim 1, wherein
the second reflection plate is located such that a normal line to the second reflection plate extends in a direction different from a normal line to the first reflection plate when viewed from the first direction.

3. The drying device according to claim 1, wherein
the first heater unit includes a plurality of first heating elements,
the first heating element is one of the plurality of first heating elements, and
the plurality of first heating elements are lined up at intervals in the first direction.

4. The drying device according to claim 3, wherein
the first reflection plate extends in the first direction so as to cover the plurality of first heating elements.

5. The drying device according to claim 3, wherein
the second heater unit includes a plurality of second heating elements,
the second heating element is one of the plurality of second heating elements, and
the plurality of second heating elements are located at positions different from
the plurality of first heating elements in the first direction and lined up at intervals in the first direction.

6. The drying device according to claim 5, wherein
the second reflection plate extends in the first direction so as to cover the plurality of second heating elements.

7. The drying device according to claim 1, further comprising:
a blower unit that performs blowing to the support base such that a gas flows over the support base, wherein
the blower unit includes
a fan that causes the gas to flow, and
a blowing path in which an outlet port is open through which the gas made to flow by the fan is blown out, and
the first reflection plate
is located such that a distance between the first reflection plate and the outlet port is shorter than a distance between the second reflection plate and the outlet port in the second direction, and
is located to block a space between the outlet port and the first heating element.

8. The drying device according to claim 1, further comprising:
a transmission member that is located between the first heating element and the support base and transmits infrared rays.

9. The drying device according to claim 8, wherein
the transmission member is attached to the first reflection plate so as to surround the first heating element with the first reflection plate and the transmission member.

10. The drying device according to claim 9, wherein
the transmission member is a first transmission member, and
the drying device comprises a second transmission member that is located between the second heating element and the support base and transmits infrared rays.

11. The drying device according to claim 10, wherein
the second transmission member is attached to the second reflection plate so as to surround the second heating element with the second reflection plate and the second transmission member.

12. The drying device according to claim 8, wherein
the transmission member is located between the first heating element and the support base and between the second heating element and the support base.

13. A printing device comprising:
a printing unit that ejects a liquid to a medium and thus performs printing;
a transport unit that transports the medium;
a support base that supports the medium to which the liquid is ejected;
a first heater unit that faces the support base and heats the medium; and
a second heater unit that faces the support base and heats the medium, wherein
the first heater unit includes
a first heating element that extends in a first direction and radiates infrared rays, and
a first reflection plate that reflects the infrared rays radiated by the first heating element toward the support base,
the second heater unit includes
a second heating element that extends in the first direction and radiates infrared rays, and
a second reflection plate that reflects the infrared rays radiated by the second heating element toward the support base,
the second heating element is located at a position different from a position of the first heating element in the first direction and a second direction that is a direction different from the first direction and in which the medium transported on the support base moves, and
the second reflection plate reflects the infrared rays such that the infrared rays overlap a region on the support base irradiated with the infrared rays reflected by the first reflection plate in the second direction.
